(19) United States
(12) Patent Application Publication
(10) Pub. No.: US 2011/0267206 A1
(43) Pub. Date: Nov. 3, 2011

(54) SYSTEMS AND METHODS FOR PROVIDING A SWATH-BASED DISPLAY OF TERRAIN HEIGHT INFORMATION

(76) Inventors: Zachary R. Reynolds, Peoria, AZ (US); Cyro A. Stone, Peoria, AZ (US); Christopher Polynin, Phoenix, AZ (US)

(21) Appl. No.: 13/098,333

(22) Filed: Apr. 29, 2011

Related U.S. Application Data
(60) Provisional application No. 61/329,309, filed on Apr. 29, 2010.

(51) Int. Cl. G08B 23/00

(52) U.S. Cl. 340/963

(57) ABSTRACT

The present invention provides a system and a method. The method includes receiving data representing a position of a host aircraft, and based on the position of the host aircraft, receiving data extracted from a database representing an elevation of at least one of a terrain and an obstacle surrounding the host aircraft. The method further includes displaying, on a display, information including the position of the host aircraft and the extracted data, and identifying a subset of the displayed information as relevant for situational awareness. Further, the method includes displaying, on the display, an indicia of a maximum elevation within the subset of the displayed information.

### CROSS REFERENCE TO RELATED APPLICATION

This application claims priority under 35 U.S.C. §119(e) of U.S. Provisional Patent Application Ser. No. 61/329,309, filed on Apr. 29, 2010. The subject matter of the earlier filed application is hereby incorporated by reference.

### BACKGROUND

1. Field

Embodiments of the invention relate to systems and methods for providing a swath-based display of terrain height information, and, in particular, to a swath-based topographical display of a position of a host aircraft, a subset of information representing an elevation of at least one of a terrain and an obstacle surrounding the host aircraft which is relevant for situational awareness, and an indicia of a maximum elevation within the subset of information.

2. Description of the Related Art

To reduce, and possibly eliminate, the occurrence of controlled flight into terrain (CFIT) accidents, the U.S. Federal Aviation Administration (FAA) developed a terrain awareness and warning system (TAWS) standard for systems that would provide a flight crew with sufficient information and alerts to detect a potentially hazardous terrain or obstacle situation. Based on the information and the alerts, the flight crew would be able to prevent a CFIT accident from occurring.

A conventional TAWS, for example a ground proximity warning system (GPWS) or an enhanced GPWS, uses digital elevation and obstacle data and airplane instrumental values to predict if a likely future position of a vehicle, for example an aircraft or a helicopter, would intersect a surrounding terrain or obstacle. These systems provide the flight crew with aural and visual warnings of conditions when the aircraft is in a potentially hazardous proximity to the terrain or obstacle, or in a hazardous flight condition given the aircraft's position relative to the terrain or obstacle.

The TAWS includes a stored terrain database and a stored obstacle database that compares the position of the aircraft in a three dimensional space with stored terrain and obstacle information to identify potential conflicts between the aircraft and a terrain or obstacle.

The TAWS includes a terrain awareness display which employs multiple display modes that are used to display in real-time a graphical indication of the position of the terrain or obstacle relative to the aircraft, i.e., a graphical indication of minimum and maximum elevations of surrounding terrain and obstacles. The graphical indication may be shown on a display in the cockpit of the aircraft. The graphical indication of minimum and maximum elevations of surrounding terrain and obstacles is useful to the flight crew, for example, in preparing for a descent into a high terrain or obstacle area.

In some displays, the terrain is color coded according to elevation or the degree of hazard that the terrain poses to the aircraft. For example, green-colored terrain depicts non-hazardous terrain below the aircraft, yellow-colored terrain depicts terrain that is in proximity to the aircraft and which might cause the TAWS to generate a warning alert. Further, red-colored terrain depicts terrain at or above the aircraft altitude for which the TAWS will generate a warning alert to alert the flight crew that evasive action must be taken to avoid the terrain. Obstacles may be represented by other indicia on the display.

As shown, for example, in FIG. 1, the terrain awareness display 100 of the conventional TAWS, however, displays an indication of every terrain 110 in the displayable area 120, even terrain 110 for those areas for which the aircraft 130 will never fly into, i.e. areas not along the present or projected track of the aircraft 130. For example, the elevation of the high terrain at a bearing in front of the aircraft 130 is 4,000 feet (040), the elevation of the high terrain at a bearing of −45° is only 3,000 feet (030), and the elevation of the high terrain at a bearing of 45° is 5,000 feet (050). The conventional TAWS would indicate that the maximum elevation 140 of the high terrain in the displayable area 120 is 5,000 feet (050). Thus, the conventional TAWS may cause the flight crew to take an unnecessary evasive maneuver or change a projected flight plan, which results in extra fuel consumption and/or a flight delay.

### SUMMARY

In accordance with an embodiment of the invention, there is provided a method, which includes receiving data representing a position of a host aircraft, and based on the position of the host aircraft, receiving data extracted from a database representing an elevation of at least one of a terrain and an obstacle surrounding the host aircraft. The method further includes displaying, on a display, information including the position of the host aircraft and the extracted data, and identifying a subset of the displayed information as relevant for situational awareness. Further, the method includes displaying, on the display, an indicia of a maximum elevation within the subset of the displayed information.

In accordance with another embodiment of the invention, there is provided a system, which includes a processor and a memory in communication with the processor. The memory is configured to store instructions that, when executed by the processor, cause the processor to receive data representing a position of a host aircraft, and based on the position of the host aircraft, receive data extracted from a database representing an elevation of at least one of a terrain and an obstacle surrounding the host aircraft. The memory is further configured to store instructions that, when executed by the processor, cause the processor to display, on a display, information comprising the position of the host aircraft and the extracted data, and identify a subset of the displayed information as relevant for situational awareness. Further, the memory is configured to store instructions that, when executed by the processor, cause the processor to display, on the display, an indicia of a maximum elevation within the subset of the displayed information.

In accordance with another embodiment of the invention, there is provided a computer program product embodied on a computer-readable storage medium. The computer program product is configured to control a processor to perform receiving data representing a position of a host aircraft, and based on the position of the host aircraft, receiving data extracted from a database representing an elevation of at least one of a terrain and an obstacle surrounding the host aircraft. The method further includes displaying, on a display, information including the position of the host aircraft and the extracted data, and identifying a subset of the displayed information as relevant for situational awareness. Further, the method includes displaying, on the display, an indicia of a maximum elevation within the subset of the displayed information.

Both the foregoing summary and the following detailed description are exemplary and explanatory only and are not restrictive of the invention.

### BRIEF DESCRIPTION OF THE DRAWINGS

Further aspects, details, advantages and modifications of the invention will become apparent from the following detailed description of the embodiments, which is to be taken in conjunction with the accompanying drawings, in which:

FIG. 1 is a topographical display of a conventional terrain awareness and warning system.

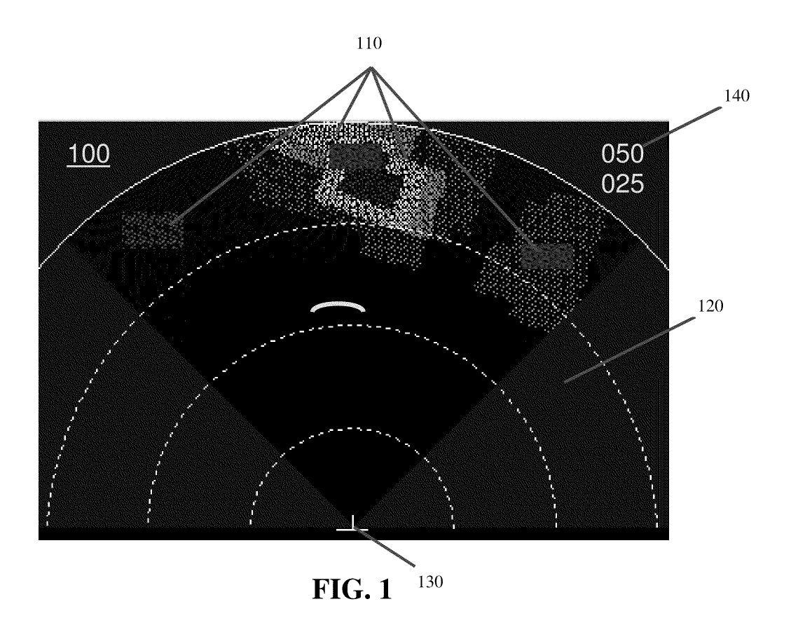

FIG. 2 is a block diagram of a system, in accordance with an embodiment of the invention.

FIG. 3 is a flow diagram of a method, in accordance with an embodiment of the invention.

FIG. 4 is a topographical display based on a flight plan of a host aircraft, in accordance with an embodiment of the invention.

FIG. 5 is topographical display based on a projected track being an extrapolation of a current track angle and a roll angle of the host aircraft, in accordance with another embodiment of the invention.

FIG. 6 is another topographical display based on a terrain awareness and warning system sensor swath, in accordance with another embodiment of the invention.

### DETAILED DESCRIPTION OF THE PREFERRED EMBODIMENT(S)

It will be readily understood that the components of the invention, as generally described and illustrated in the figures herein, may be arranged and designed in a wide variety of different configurations. Thus, the following detailed description of the embodiments of the systems and methods for providing a swath-based display, as represented in the attached figures, is not intended to limit the scope of the invention as claimed, but is merely representative of selected embodiments of the invention.

Embodiments of the invention provide an improved TAWS, which provides a swath-based display, for example a topographical display, of a position of a host aircraft, a subset of information representing an elevation of at least one of a terrain and an obstacle surrounding the host aircraft which is relevant for situational awareness, and an indicia of a maximum elevation within the subset of information. According to the embodiments of the invention, the improved TAWS provides a flight crew with an enhanced situational awareness capability including an indication of potential hazards (e.g., both terrain and obstacles) in a current flight path or projected flight path of the host aircraft. Certain embodiments of the invention further provide an improved TAWS that compares potential hazards in the current flight path or the projected flight path with a TAWS sensor swath for a distance based on a predetermined period of time in front of the host aircraft.

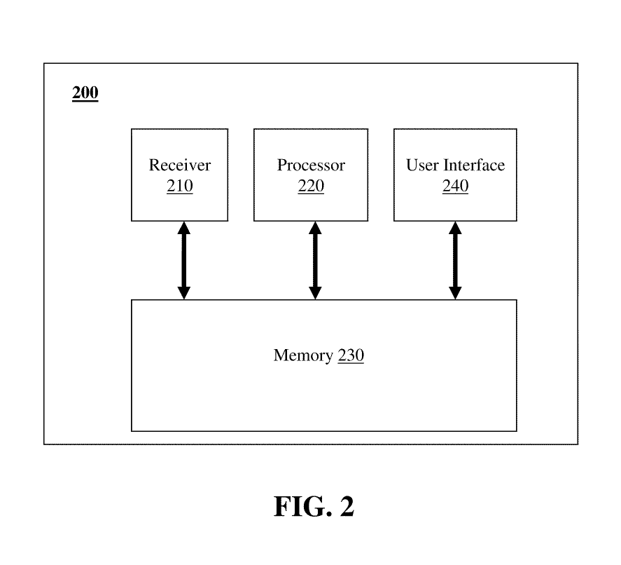

FIG. 2 is a block diagram of a system, in accordance with an embodiment of the invention. The system 200 may include a receiver 210, a processor 220 in communication with a memory 230, and a user interface 240. The system 200 may operate separately and distinctly from, or as part of, or in conjunction with, any number of other systems and devices, such as an existing TAWS, a traffic collision avoidance system (TCAS), an aircraft transponder, a weather radar system (WXR), a reactive windshear system (RWS), a predictive windshear system (PWS) or any other system or device now or hereafter developed for use on an aircraft, such as a fixed-wing aircraft or a rotary-winged aircraft (hereinafter referred to as the “host aircraft”).

The components of the system 200 may be distributed across any number of different systems and devices, and need not be physically connected to one another. The system 200 may be located on board, or external to, the host aircraft for which situational awareness of terrain and obstacles surrounding the host aircraft is required. The components of the system 200, as will be described in more detail below, may communicate with one another, as desired, as well as with any other system or device on board, or external to, the host aircraft. The system 200 may additionally include, or communicate with, any other appropriate components.

The receiver 210 may receive data via a wired connection or wirelessly through one or more antennas (not shown). The receiver 210 may be combined with a transmitter (i.e., a transceiver) (not shown) and may further receive electrical signals, radio frequency signals, modulated light signals, sonic signals, or other signals propagated through any suitable medium. The receiver 210 may include any suitable receiver and may receive data using any number of frequencies and may use any communication protocol. The receiver 210 may receive any type of data or information, such as a position, a velocity, a current or projected track, or other data or information pertaining to the host aircraft. The receiver 210 may further receive any data extracted from a database on board, or external to, the system 200. For example, the database may include a terrain database or an obstacle database which may include man-made and certain natural obstacles extracted from digital and paper sources provided by, for example, governmental civil aviation authorities and military agencies worldwide.

The processor 220 may retrieve and execute instructions that may be stored in the memory 230 to control operation of the system 200. Although only one processor is shown in FIG. 2 and discussed in detail, certain embodiments of the invention provide more than one processor in the system 200. The processor 220 may be of any type suitable to the local technical environment, and may include one or more of general purpose computers, special purpose computers, microprocessors, microcontrollers (MRUs), digital signal processors (DSPs), and processors based on multi-core processor architecture, as non-limiting examples.

The memory 230 may store instructions, data received from one or more data sources (i.e., a terrain database or an obstacle database), and any other suitable data or information. The memory 230, operating in conjunction with embodiments of the invention, may be of any type suitable to the local technical environment and may be implemented using any suitable data storage technology, machine or computer readable storage medium, such as semiconductor-based memory devices, flash memory, magnetic memory devices and systems, optical memory devices and systems, fixed memory and removable memory, as non-limiting examples. Any number of memory storage devices of any size and configuration may also be used in conjunction with embodiments of the invention.

The user device 240 may receive input from, and provide output to, one or more users, such as an operator of the host aircraft on which the system is located or an individual external to the host aircraft, such as an air traffic controller (hereinafter referred to as “the user”). The user interface 240 may include any number of suitable systems or devices to provide information and receive various inputs. The user interface 240 may further include one or more visual displays and/or speakers to communicate information, such as an alert (i.e., both visual and aural), to the user. A user can provide input to the user interface 240 through any suitable input device, such as a mouse, a touchpad, a microphone, or any number of other input devices.

In accordance with an embodiment of the invention, the memory 230 is configured to store instructions that, when executed by the processor 220, cause the processor 220 to receive data representing a position of a host aircraft. The data representing the position of the host aircraft may include, for example, heading, altitude, longitude and latitude, vertical speed, ground speed, track angle, and roll angle of the host aircraft. The data may be received from, for example, a global positioning system (GPS), a flight management system (FMS), or an inertial reference system (IRS).

The memory 230 is further configured to store instructions that, when executed by the processor 220, cause the processor 220 to, based on the position of the host aircraft, receive data extracted from a database representing an elevation of at least one of a terrain and an obstacle surrounding the host aircraft. The database may include a single database or separate databases which may be on board, or external to, the system 200 of the host aircraft. The extracted data may include information, relating to man-made and certain natural obstacles and associated elevation data over which the host aircraft is flying or is projected to fly over, which has been extracted from digital and paper sources provided by, for example, governmental civil aviation authorities and military agencies worldwide.

The memory 230 is further configured to store instructions that, when executed by the processor 220, cause the processor 220 to display, on a display of the user interface 240, information including the position of the host aircraft and the extracted data. The display of the user interface 240 may depict the position of the host aircraft and the extracted data using one or more graphical or numerical indicia or representations. For example, the display of the user interface 240 may depict the extracted data using color codes such as sectional charts. The colors may depict elevations for the terrain or the obstacle above sea level, may depict elevations for the terrain or the obstacle compared to current aircraft altitude or may depict the relative hazard-potential of the terrain or the obstacle based on the data representing the position of the host aircraft.

Further, the memory 230 is configured to store instructions that, when executed by the processor 220, cause the processor 220 to identify a subset of the displayed information as relevant for situational awareness. In accordance with certain embodiments of the invention, the subset of the displayed information is based on one of a flight plan for the host aircraft, a projected track of the host aircraft, the projected track being an extrapolation of a current track angle and a roll angle of the host aircraft, and a TAWS sensor swath. The flight plan and the projected track of the host aircraft may be retrieved during, or at another time, the receiving of the data representing the position of the host aircraft. The TAWS sensor may include any suitable type of sensor compatible with a TAWS, such as a Class-A or Class-B TAWS.

The memory 230 is further configured to store instructions that, when executed by the processor 220, cause the processor 220 to display, on the display of the user interface 240, an indicia of a maximum elevation within the subset of the displayed information. According to certain embodiments of the invention, the indicia of the maximum elevation may be depicted as a numerical representation, or any other suitable representation that identifies to the user of the system 200 the elevation of the terrain or the obstacle along a path defined by the flight plan, the projected track, or along a TAWS sensor swath of the host aircraft. In accordance with another embodiment of the invention, an indicia of the minimum elevation within the subset of the displayed information is also displayed on the display of the user interface 240. As with the maximum elevation, the indicia of the minimum elevation within the subset of the displayed information may also be depicted as a numerical representation, or any other suitable representation that identifies to the user of the system 200 the elevation of the terrain or the obstacle along a path defined by the flight plan, the projected track, or along a TAWS sensor swath of the host aircraft. The maximum elevation and the minimum elevation within the subset of the displayed information may be identified for an area defined between the host aircraft and an edge of the display of the user interface 240.

The TAWS sensor swath, according to an embodiment of the invention, may be defined by, for example, a 1.5 degree diverging coverage angle extending outward on either side of the host aircraft.

In accordance with another embodiment of the invention, the memory 230 is further configured to store instructions that, when executed by the processor 220, cause the processor 220 to identify the maximum elevation within the subset of the displayed information for a distance based on a predetermined period of time in front of the host aircraft. The predetermined period of time may be, for example, 20 to 132 seconds in front of the host aircraft.

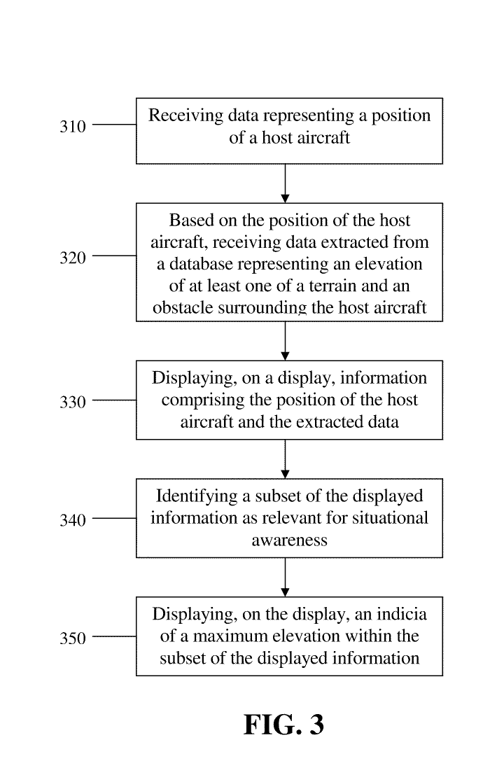

FIG. 3 is a flow diagram of a method, in accordance with an embodiment of the invention. The method includes receiving, in step 310, data representing a position of a host aircraft. Based on the position of the host aircraft, in step 320, data extracted from a database representing an elevation of at least one of a terrain and an obstacle surrounding the host aircraft is received. The method further includes displaying, in step 330, on a display of the user interface, information including the position of the host aircraft and the extracted data. In step 340, the method includes identifying a subset of the displayed information as relevant for situational awareness. The method further includes displaying, in step 350, on the display of the user interface, an indicia of a maximum elevation within the subset of the displayed information.

The method further includes identifying the subset of the displayed information based on one of the flight plan for the host aircraft, the projected track of the host aircraft, the projected track being an extrapolation of a current track angle and a roll angle of the host aircraft, and the TAWS sensor swath. As previously noted, the flight plan and the projected track of the host aircraft may be retrieved during, or at another time, the receiving of the data representing the position of the host aircraft.

In accordance with another embodiment of the invention, the method may further include identifying and displaying on the display of the user interface the indicia of the minimum elevation within the subset of the displayed information. As with the maximum elevation, the indicia of the minimum elevation within the subset of the displayed information may be depicted as a numerical representation, or any other suitable representation that identifies to the user of the system, as discussed above, the elevation of the terrain or the obstacle along a path defined by the flight plan, the projected track, or along a TAWS sensor swath of the host aircraft. The maximum elevation and the minimum elevation within the subset of the displayed information may be identified for an area defined between the host aircraft and an edge of the display of the user interface.

Further, the method may include identifying the subset of the displayed information based on the TAWS sensor swath defined by for example a 1.5 degree diverging coverage angle extending outward on either side of the host aircraft.

In accordance with another embodiment of the invention, the method may further include identifying the maximum elevation within the subset of the displayed information for a distance based on a predetermined period of time in front of the host aircraft. The predetermined period of time may be, for example, 20 to 132 seconds in front of the host aircraft.

In the method depicted in FIG. 3, data can be requested and/or received from one or more data sources, including a database, such as a terrain database or an obstacle database, and any system, device, vehicle, or other entity capable of providing information for use with embodiments of the invention, including one or more systems or devices implementing embodiments of the invention. Such information may be of any type and in any format, and may include, or be used to determine position information (e.g., heading, altitude, longitude and latitude, vertical speed, ground speed, track angle, and roll angle) of the host aircraft, or the elevation of at least one of a terrain and an obstacle surrounding the host aircraft, based on the position of the host aircraft, as well as for other purposes.

Embodiments of the invention may receive information at regular intervals and/or in response to an event, regardless of whether the information has been requested. For example, embodiments of the invention can receive data periodically from the GPS, FMS, or IRS, or other system or device which identifies the position of the host aircraft. Embodiments of the invention can further receive data representing the elevation of terrain and obstacles based on the position of the host aircraft. Data can be provided wirelessly from a data source to a system or device (such as system 100) implementing methods in accordance with embodiments of the invention. Such information can be provided on any frequency (or combination of frequencies), in any format, and using any communication protocol.

A computer program code, according to certain embodiments of the invention, may be composed of algorithms or modules that are in operative communication with one another, and which are designed to pass information or instructions to the system 200. The computer program code may be configured to operate on a general purpose computer, special purpose computer, microprocessor, MRU, DSPs, an application specific integrated circuit (ASIC), and a processor based on multi-core processor architecture, as non-limiting examples.

The computer readable medium (i.e., a non-transitory computer readable medium) may include any media or means that can contain, store, communicate, propagate or transport the instructions for use by or in connection with an instruction execution system, apparatus, or device, for example, a disk media, computer memory, or other storage device. Non-transitory storage medium does not include a transitory signal. Examples of non-transitory storage medium include, for example, a computer-readable medium, a computer distribution medium, a computer-readable storage medium, and a computer program product.

The embodiments of the invention discussed above may be implemented by hardware, computer software executable by one or more of the processor 220 of the system 200, respectively, or by a combination of hardware and software.

The software and/or hardware may reside on system 200, or other system or device. If desired, part of the software and/or hardware may reside on the system 200, and part of the software and/or hardware may reside on other systems or devices on board, or external to, the host aircraft. In an embodiment of the invention, software, or an instruction set may be maintained on any one of various conventional computer-readable media.

In accordance with an embodiment of the invention, there is provided a computer program product embodied on a computer readable storage medium. The computer program product is encoded with instructions to control a processor to perform a process. The process includes receiving data representing a position of a host aircraft, and based on the position of the host aircraft, receiving data extracted from a database representing an elevation of at least one of a terrain and an obstacle surrounding the host aircraft. The process further includes displaying, on a display, information comprising the position of the host aircraft and the extracted data, and identifying a subset of the displayed information as relevant for situational awareness. Further, the process includes displaying, on the display, an indicia of a maximum elevation within the subset of the displayed information.

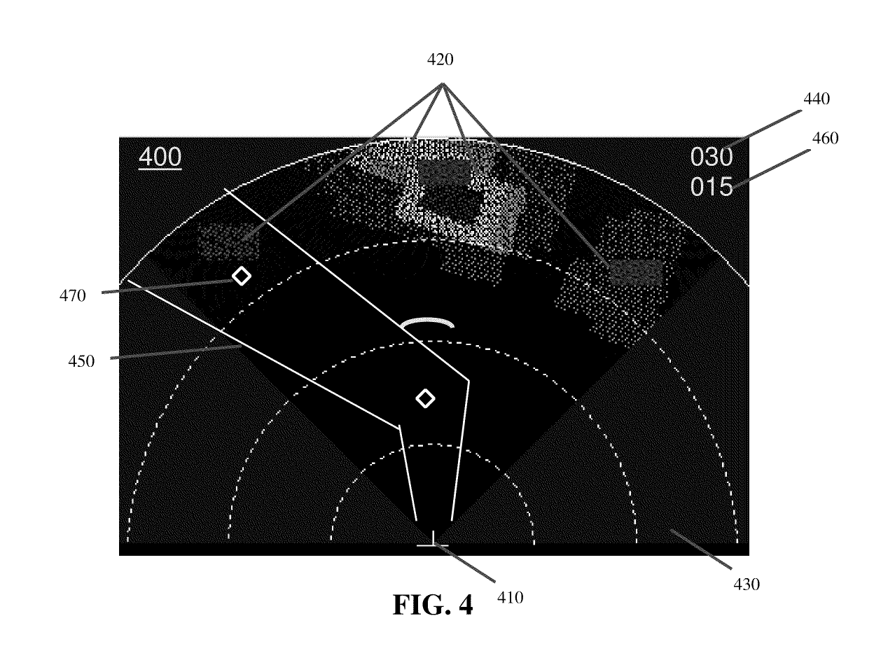

In accordance with various embodiments of the invention, a swath-based display of terrain and obstacle information may be provided. As will be discussed in more detail below and illustrated in FIGS. 4-6, the swath-based display may further include an identification of a subset of the displayed information, relevant for situational awareness, which is based on one of a flight plan for the host aircraft, a projected track of the host aircraft, the projected track being an extrapolation of a current track angle and a roll angle of the host aircraft, and a sensor swath. An indicia of the maximum elevation within the subset of the displayed information is displayed, providing the user with an enhanced situational awareness capability for identifying potential terrain and obstacles in the current or projected flight path of the host aircraft, allowing the user to make the necessary changes to the flight plan or projected path of the host aircraft to avoid the terrain and obstacles. For ease of illustrating certain embodiments of the invention, FIGS. 4-6 only show terrain and the maximum and minimum elevation associated therewith in the displayable area of the display, although embodiments of the invention, as discussed above, include the identifying and displaying of obstacles. Furthermore, for each of FIGS. 4-6, the elevation of the high terrain 420 at a bearing in front of the host aircraft 410 is 4,000 feet (040), the elevation of the high terrain 420 at a bearing of −45° is 3,000 feet (030), and the elevation of the high terrain 420 at a bearing of 45° is 5,000 feet.

FIG. 4 is a topographical display based on a flight plan of a host aircraft, in accordance with an embodiment of the invention. In this example, a topographical display 400 is provided for a host aircraft 410 which displays a position of the host aircraft 410 and every terrain 420 in the displayable area 430, even terrain for those areas for which the host aircraft 410 will never fly into, i.e. areas not along the present or projected track of the host aircraft 410. The topographical display 400, according to an embodiment of the invention, further displays a maximum elevation 440 of the terrain 420 along the flight plan path 450 of the host aircraft 410. As further shown in FIG. 4, the topographical display 400 can further display the minimum elevation 460 of the terrain 420 in this defined area. Waypoints 470 may further be provided on the topographical display 400 representing navigational points along the flight plan path 450 as further indicators to the user of reference points between the host aircraft 410 and the terrain 420. Accordingly, the topographical display 400, in accordance with an embodiment of the invention as shown in FIG. 4, provides the user with the situational awareness of the maximum 440 (i.e., 3,000 feet (030)) and minimum 460 (i.e., 1,500 feet (015)) elevations of the terrain 420 along the flight plan path 450 of the host aircraft 410, allowing the user to make the necessary changes to the flight plan 450 of the host aircraft 410 to avoid the terrain 420. For example, a user of the topographical display 400 may use the maximum 440 and minimum 460 elevations of the terrain 420 to navigate the host aircraft 410 to avoid high terrain 420 or to provide the user with optional escape routes through lower terrain 420. According to this embodiment of the invention, the user is not distracted by indications of elevation for terrain 420 that are not in the flight plan path 450 of the host aircraft 410.

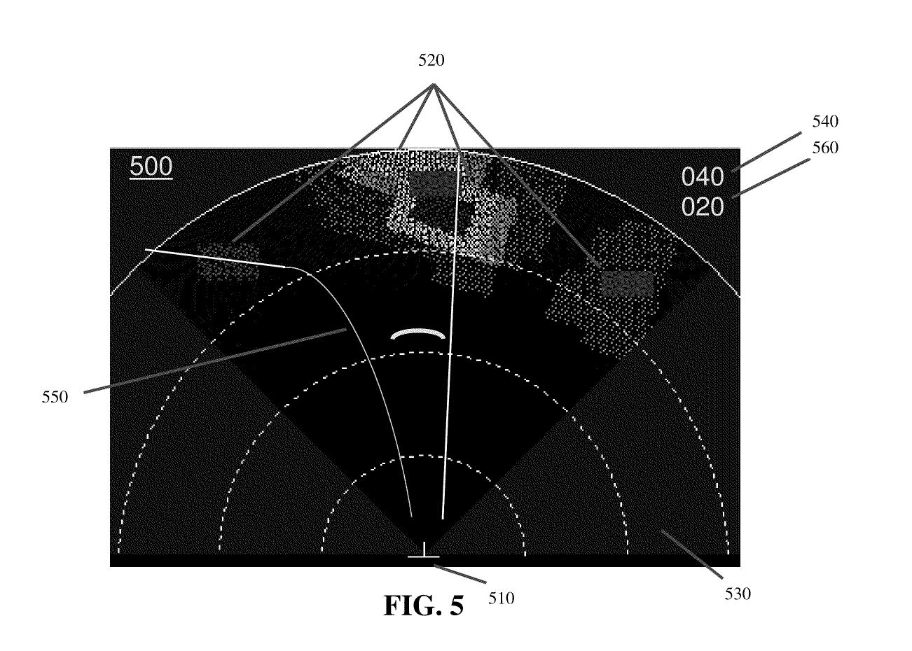

FIG. 5 is topographical display based on a projected track being an extrapolation of a current track angle and a roll angle of the host aircraft, in accordance with another embodiment of the invention. Referring to FIG. 5, a topographical display 500 is provided for a host aircraft 510 which displays a position of the host aircraft 510 and every terrain 520 in the displayable area 530, as similarly illustrated in FIG. 4. The topographical display 500, according to an embodiment of the invention, further displays a maximum elevation 540 of the terrain 520 along a projected track 550 of the host aircraft 510, the projected track 550 including an extrapolation of a current track angle and a roll angle of the host aircraft 510. As further shown in FIG. 5, the topographical display 500 can further display the minimum elevation 560 of the terrain 520 in this defined area. Accordingly, the topographical display 500, in accordance with an embodiment of the invention as shown in FIG. 5, provides the user with the situational awareness of the maximum 540 (i.e., 4,000 feet (040)) and minimum 560 (i.e., 2,000 feet (020)) elevations of the terrain 520 along the projected track 550 of the host aircraft 510, allowing the user to make the necessary changes to the projected track 550 of the host aircraft 510 to avoid the terrain 520, as similarly discussed above for the embodiment shown in FIG. 4. According to this embodiment of the invention, the user is also not distracted by indications of elevation for terrain 520 that are not in the projected track 550 of the host aircraft 510.

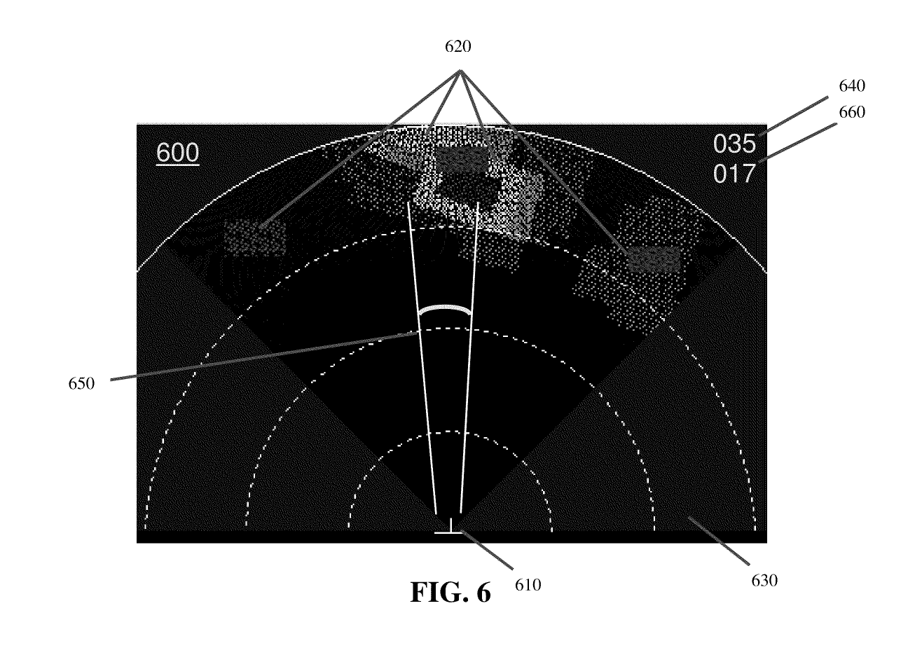

FIG. 6 is another topographical display based on a TAWS sensor swath, in accordance with another embodiment of the invention. In this example, a topographical display 600 is provided for a host aircraft 610 which displays a position of the host aircraft 610 and every terrain 620 in the displayable area 630, as similarly illustrated in FIGS. 4 and 5. For illustrative purposes, the host aircraft 610 is currently traveling along a path of a TAWS sensor swath 650 at a bearing straight ahead (at a bearing of 0°) 650. The topographical display 600, according to an embodiment of the invention, further displays a maximum elevation 640 and minimum 660 elevations of the terrain 620 ahead of the host aircraft 610. In accordance with this embodiment of the invention, a TAWS sensor identifies the maximum 640 and minimum 660 elevations of terrain 620 for a distance based on a predetermined period of time in front of the host aircraft 610 along the path of the TAWS sensor swath 650. In this example, the TAWS sensor is looking 8 Nm forward with a 120 second look ahead at a speed of 240 knots (i.e., 4 Nm per minute). According to this embodiment of the invention, a user may be able to compare the maximum 640 and minimum 660 elevations of terrain 620 identified by system, such as system 200 discussed above, with the elevations identified by the TAWS sensor swath.

One having ordinary skill in the relevant art will readily understand that the particular implementations shown and described above are illustrative of embodiments of the invention and the best mode and are not intended to otherwise limit the scope of the invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the present invention. Changes and modifications may be made to the disclosed embodiments without departing from the scope of the present invention. These and other changes or modifications are intended to be included within the scope of the present invention, as expressed in the following claims.

We claim:

1. A method, comprising:
receiving data representing a position of a host aircraft;
based on the position of the host aircraft, receiving data extracted from a database representing an elevation of at least one of a terrain and an obstacle surrounding the host aircraft;
displaying, on a display, information comprising the position of the host aircraft and the extracted data;
identifying a subset of the displayed information as relevant for situational awareness; and
displaying, on the display, an indicia of a maximum elevation within the subset of the displayed information.

2. The method of claim 1, wherein the identifying comprises identifying the subset of the displayed information based on a flight plan for the host aircraft.

3. The method of claim 1, wherein the identifying comprises identifying the subset of the displayed information based a projected track of the host aircraft, the projected track being an extrapolation of a current track angle and a roll angle of the host aircraft.

4. The method of claim 1, wherein the identifying comprises identifying the subset of the displayed information based on a sensor swath.

5. The method of claim 4, wherein the identifying comprises identifying the subset of the displayed information based on the sensor swath, wherein the sensor swath is defined by a 1.5 degree diverging coverage angle extending outward on either side of the host aircraft.

6. The method of claim 1, further comprising:
displaying, on the display, an indicia of a minimum elevation within the subset of the displayed information.

7. The method of claim 1, further comprising:
identifying the maximum elevation within the subset of the displayed information for a distance based on a predetermined period of time in front of the host aircraft.

8. The method of claim 7, wherein the identifying the maximum elevation comprises identifying the maximum elevation within the subset of the displayed information for a distance of 8 to 220 seconds in front of the host aircraft.

9. The method of claim 1, further comprising:
identifying the maximum elevation within the subset of the displayed information for an area defined between the host aircraft and an edge of the display.

10. A system, comprising:
a processor; and
a memory in communication with the processor, wherein the memory is configured to store instructions that, when executed by the processor, cause the processor to:
receive data representing a position of a host aircraft;
based on the position of the host aircraft, receive data extracted from a database representing an elevation of at least one of a terrain and an obstacle surrounding the host aircraft;
display, on a display, information comprising the position of the host aircraft and the extracted data;
identify a subset of the displayed information as relevant for situational awareness; and
display, on the display, an indicia of a maximum elevation within the subset of the displayed information.

11. The system of claim 11, wherein the memory is further configured to store instructions that, when executed by the processor, cause the processor to identify the subset of the displayed information based on a flight plan for the host aircraft.

12. The system of claim 11, wherein the memory is further configured to store instructions that, when executed by the processor, cause the processor to identify the subset of the displayed information based a projected track of the host aircraft, the projected track being an extrapolation of a current track angle and a roll angle of the host aircraft.

13. The system of claim 11, wherein the memory is further configured to store instructions that, when executed by the processor, cause the processor to identify the subset of the displayed information based on a sensor swath.

14. The system of claim 14, wherein the memory is further configured to store instructions that, when executed by the processor, cause the processor to identify the subset of the displayed information based on the sensor swath, wherein the sensor swath is defined by a 1.5 degree diverging coverage angle extending outward on either side of the host aircraft.

15. The system of claim 14, wherein the memory is further configured to store instructions that, when executed by the processor, cause the processor to display, on the display, an indicia of a minimum elevation within the subset of the displayed information.

16. The system of claim 11, wherein the memory is further configured to store instructions that, when executed by the processor, cause the processor to identify the maximum elevation within the subset of the displayed information for a distance based on a predetermined period of time in front of the host aircraft.

17. The system of claim 17, wherein the memory is further configured to store instructions that, when executed by the processor, cause the processor to identify the maximum elevation within the subset of the displayed information for a distance of 8 to 220 seconds in front of the host aircraft.

18. The system of claim 11, wherein the memory is further configured to store instructions that, when executed by the processor, cause the processor to identify the maximum elevation within the subset of the displayed information for an area defined between the host aircraft and an edge of the display.

19. A computer program product embodied on a computer-readable storage medium, the computer program product being configured to control a processor to perform:
receiving data representing a position of a host aircraft;
based on the position of the host aircraft, receiving data extracted from a database representing an elevation of at least one of a terrain and an obstacle surrounding the host aircraft;
displaying, on a display, information comprising the position of the host aircraft and the extracted data;
identifying a subset of the displayed information as relevant for situational awareness; and
displaying, on the display, an indicia of a maximum elevation within the subset of the displayed information.

20. The computer program product of claim 20, wherein the computer program product is configured to control the processor to perform identifying the subset of the displayed information based on one of a flight plan for the host aircraft, a projected track of the host aircraft, wherein the projected track is an extrapolation of a current track angle and a roll angle of the host aircraft, and a sensor swath.
